(19) United States
(12) Patent Application Publication
(10) Pub. No.: US 2007/0161534 A1
(43) Pub. Date: Jul. 12, 2007

(54) Detergent compositions with improved malodour properties and process to make them

(76) Inventors: Renee Boerefijn, Vlaardingen (NL); Janette Cutrona, Paulo-SP (BR); Marco Klaver, Vlaardingen (NL); Juliette Louise Old, Warrington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/580,889

(22) PCT Filed: Nov. 10, 2004
(86) PCT No.: PCT/EP04/12757

§ 371 Date: Feb. 8, 2007

(30) Foreign Application Priority Data
Nov. 28, 2003 (EP) 03257506.0

(51) Int. Cl. C11D 17/00

(52) U.S. Cl. 510/444; 510/446; 510/424

(57) ABSTRACT

The invention concerns powdered detergent compositions that display less malodour and less degradation than known powdered detergent compositions, these compositions comprise at least surfactants, sequestrants and/or anti-oxidants, while also heavy metal ions are present. Other components such as support material, soaps, bound water, builders and perfumes can also be present. The invention also concerns a process to make these compositions wherein specific components are added to a mixer through different ports of addition situated downstream from each other.

The occurrence of malodour in detergent compositions that contain anionic surfactants and/or soaps based on long chain fatty acids salts is a known phenomenon which needs to be solved. Another problem that exists in these known compositions is the degradation of the components of these compositions that takes place upon storage, resulting in products of lower (and even too low) quality for the consumer. Finding a method to prevent this degradation would therefore be very beneficial.

Although malodour problems are disclosed in the prior art these problems so far are not solved in a way that is applicable to all systems required. Therefore we studied whether we could find new routes and new products solving this malodour problem in an economic and attractive way suitable to in particular compositions made by VRV type processing but also to other systems than mentioned in the prior art so far.

Simultaneously we studied whether we also could overcome the degradation problems set out above.

WO 99/21954 discloses a method for masking malodours in laundry compositions by adding so called pro-accord or pro-fragrances compositions. These pro-compositions slowly release a fragrance material which will mask the malodour that is formed during storage or use of the laundry composition. The pro-compositions thus do not prevent the forming of malodours and further are expensive and inconvenient in use because first the pre-accord compositions have to be made while its use only slightly will mask the malodour during a limited time.

According to U.S. Pat. No. 4,153,583 solid surfactant compositions are made by a drying process and as a result of the high temperatures applied during drying oxidation of anionic surfactant may occur. This can be prevented by the addition of a specific anti-oxidant (a hydroxyphenyl alkane derivative). Nothing is mentioned about the development and the prevention of malodours.

Japanese patent application 54-093407 indicates the use of the combination of a metal chelating agent, an anti-oxidant and an UV absorber (=benzophenone) to overcome photo-oxidation of fatty acids in fats or surfactants. Our compositions do not contain benzophenone.

U.S. Pat. No. 4,026,814 reveals the use of oxido-reductase enzymes to remove malodour components from soaps, which develop malodour during storage.

WO 96/06151 discloses detergent compositions with improved stability due to the presence of low levels of anti-oxidants. The compositions can contain components such as anionic surfactants; other non-soap surfactants; builders; anti-oxidants; sequestrants for metal ions; and have bulk densities of 650 g/l or more. However the document does not reveal compositions containing metal ions that can catalyse the oxidation of fatty acids and therefore its disclosures cannot be used to find a solution for the prevention of the occurrence of malodours in laundry compositions containing heavy metal ions that can catalyse oxidation reactions.

EP 656 825 reveals a method for the production of granular detergent systems that have a high bulk density and wherein a liquid binder paste based on at least 10 wt % neutralised anionic surfactant is added to a finely divided powder in moderate speed mixer/agglomerator. The paste should have a viscosity at 70° C. and a shear rate of 25 s-1 of 5,000 to 10,000,000 cps. The paste contains preferably from 5 to 40 wt % water. This document does not present a solution for how to distribute homogeneously an anti-oxidant in a laundry composition so that the occurrence of malodour is prevented.

EP 1 035 199 (and also EP 1.035 198) discloses tablets that display a malodour type of problem and also a discolouration problem which is attributed to the presence of clay in the tablets in particular in the coating of these tablets. The presence of heavy metal ions in the tablet compositions is assumed to play a role in the occurrence of the malodour. The problem is believed to be due to the close physical proximity between the perfumes and the clay given by the tablets. The problem is overcome by the presence of sequestrants in the coatings of the tablets. We are dealing with a different type of products i.e. with powder formulations and not with tablets and herein the perfumes and the clay are not in close proximity as is the case in tablets, still we noticed that the powders displayed a malodour which problem needed to be solved as well to make the powders acceptable for the consumers.

Therefore we have looked into this problem setting again and found a solution herefore. This solution resulted in novel powdered detergent compositions and in a novel process to make these compositions.

Our study resulted in the finding of novel compositions, which do not display the negative aspects of the known compositions.

Therefore, our invention concerns, in the first instance, a powdered detergent composition as obtained by a thin layer drying process and comprising:
1 wt % to balance of anionic surfactants
0 to 25 wt %, preferably 1 to 10 wt % of fatty acid derivatives, in particular fatty acid soaps
up to 75 wt %, in particular 1 to 25 wt % of a support material
less than 25 wt %, preferably less than 10 wt % and in particular 1 to 5 wt % of total water (i.e. sum of free and bound water)
0 to 3 wt % of perfumes
0 to 75 wt % , preferably 0 to 50 wt % and in particular 5 to 30 wt % of builder material
0.05 to 5 wt %, in particular 0.1 to 3 wt % and most preferably 0.2 to 2 wt % of a sequestrant and/or anti-oxidant, while the composition contains more than 10 ppm, in particular 10 to 1000 ppm of transition metal ions, in particular derived from Fe or Cu.

A typical example of a thin layer drying process is a process wherein a VRV mixer is applied, in particular under the conditions set out below when discussing the process particulars. Typical conditions and details relating to the use of VRV mixers can for example be found in EP0777720, WO02/24853, and WO02/24854. The process of the invention may most preferably be carried out in a flash reactor. Suitable flash reactors include e.g. the Flash Drier system available from VRV SpA Impianti Industriali. The drying zone of the reactor may have a heat transfer area of at least 10 m². The cooling zone of the reactor desirably has a heat transfer area of at least 5 m².

In these compositions the amount of anionic surfactants can range over a broad range. The minimum amount being 1 wt %, preferably 5 wt %, most preferably 10 wt %, while the maximum amount can be as high as 85 wt %, preferably 75 wt %, most preferably 70 wt %.

Although fatty acid derivatives (in particular soaps) support material, perfumes and builder material can be present as optional components; we have a preference for compositions wherein at least one of these components is present. Most preferred are compositions wherein all these components are present in the amounts mentioned as preferred amounts above.

An essential component in our compositions is the sequestrant and/or anti-oxidant. Without this component the beneficial effects of our novel compositions cannot be achieved.

The total amount of water in our compositions is controlled by the production process and by the components selected in our compositions. In general the amount of bound water is difficult to control and therefore the components in our compositions must be chosen carefully in order to avoid that too much water is introduced in our compositions.

The presence of the transition metal or heavy metal ions in our novel compositions is essential in the sense that in the absence of these ions the malodor and degradation problems would not occur. These transition metals can be introduced as part of one or more of the components of the total composition, but can also be added separately.

The anionic surfactant can be any of the known anionic surfactants e.g. as listed in EP 777 719. However we have a preference for the application of salts of LAS and PAS surfactants. LAS being long chain alkyl benzene sulphonates and PAS being primary alkyl sulphates.

The soaps that can be present preferably are derived from fatty acids with 12 to 20 carbon atoms, in particular 16 to 18 carbon atoms.

The sequestant and or anti-oxidant are preferably selected from the group consisting of: EDTA; STP; Citric acid; a BHT derivative such as Tinogard®; or Irganox® or Tetronic® (i.e. an oxirane ether containing polymer from Ciba Specialty Chemicals).

The support material is used to carry the surfactants and to provide structure to the granules and can be selected from the group consisting of: zeolites; Al-silicates; silicates, alkali carbonates or alkali hydrogencarbonates; cellulose derivatives; other polysaccharides; polymers or copolymers from Na-acrylate. A preference exists for the use of zeolites and/or carbonates as support material.

Although our compositions aim for the presence of high levels of anionic surfactants our compositions also can contain some amounts of other surfactants. In particular it was found that the presence of up to 20 wt % of non-ionic and/or cationic surfactants leads to beneficial results. The type of non-ionic and cationic surfactant can be chosen freely from the known non-ionics and cationics (c.f. for a listing EP 985016, U.S. Pat. No. 4,206,069, EP 265 203) although we prefer to apply a NI 7 EO or a NI 5 EO (i.e. a non-ionic surfactant with resp 7 and 5 ethylene oxide residues) or a cationic such as Praepagen from BASF.

Another advantage of our novel compositions over the compositions of the prior art is that our compositions are in general free of an ultraviolet absorber.

The compositions that have the best product properties/performance have an untapped bulk density of more than 600 g/l.

Although we can use any of the known equipments disclosed in the prior art such as scraped wall heat exchanger/drier/mixer or high shear mixer granulator or medium shear mixer granulator or low shear mixer granulator or Lodiger or fluidised bed, we found that it is beneficial in order to achieve the aimed benefits that some of the components present in the compositions are introduced in the mix at a certain point in the process. Therefore our invention also concerns a process for the production of powdered detergent compositions with the composition according to our invention, wherein the ingredients of the detergent composition, comprising at least part of the total amount present in the whole composition of at least one of the ingredients selected from the group consisting of support material, anti-oxidant and sequestrant are introduced in a mixer at a first point of introduction and homogenised at a temperature between 10 and 160° C. while the remainder of anti-oxidant and/or sequestrant and/or support material is introduced in the mixer at a second point of introduction downstream from the first point of introduction, while the mixture obtained can be sprayed dried by spraying it on the support material.

Important in this process is thus that at least part of the support material and/or anti-oxidant and/or sequestrant are introduced in the mixer at a point downstream of the first point of introduction. Although part of these components, either as components per se, or as a mixture of components can be introduced via the first point of introduction (i.e. via port 1) the remainder of at least one of these components, in particular the remainder of anti-oxidant and/or sequestrant always should be introduced downstream of this first port.

Although the mixer can be selected from the mixers mentioned above we have a preference for the use of a specific mixer within this group of mixers and therefore we prefer to use a mixer selected from a VRV mixer but also a Lodiger recycler Konico or a Lodiger Plough share CB-30, or a fluidised bed can be used.

Typical process conditions that can be applied will be slightly different for the different mixers. When using a VRV mixer these conditions typically are the use of a tip speed of 10 to 50 m s⁻¹, preferably 18-45 and most preferably 30 to 40 m.s⁻¹, and a distance between wall and blades of up to 10 mm.

Further this mixer is preferably used with a heater shell area of up to 32 m², an inner superficial gas velocity (countercurrent) of up to 4 m.s⁻¹, pref up to 2 m.s⁻¹ and a residence time of up to 300 sec, preferably up to 60 sec.

Using a Lodiger we prefer to apply a residence time of 0.5 to 5 minutes. Using an FBG (=Fluidised Bed Granulator) we prefer residence times of at least 1 minute.

### EXAMPLES AND COMPARATIVE EXAMPLES

### Example 1

Process: VRV, 860 rpm, jackets 1 and 2: 160° C., 3: 15° C., throughput 152 kg hr⁻¹.

Configuration: LAS and carbonate feed at beginning (port 1), sulphate through jacket 1 (port 2), zeolite between jackets 2 and 3.

Formulation: 65% wt NaLAS, 18% wt Zeolite 4A, 12% carbonate, 1% sulphate, 4% moisture.

LAS acid in some cases spiked with 50 ppm Fe from FeSO₄ When included, Tinogard is pre-mixed with Zeolite.

Malodor scores after 7 days at 45° C. in closed jars:

| | | | Granule Fe |
|---|---|---|---|
| Code | Composition | Malodor | content (ppm) |
| L2277- | Not spiked | 2 | 10 |
| 01/75 | | | |
| L2277- | Spiked | 3.5 | 26 |
| 02/45 | | | |
| L2277- | Spiked, 0.25% wt | 3 | 26 |
| 03/45 | Tinogard | | |
| L2277- | Spiked, 0.5% wt | 1.5 | 26 |
| 04/45 | Tinogard | | |

### Example 2

Process: VRV, 860 rpm, jackets 1 and 2: 160° C., 3: 15° C., throughput 152 kg hr⁻¹

Configuration: LAS and carbonate feed at beginning, zeolite between jackets 2 and 3, sulphate through jacket 1 (port 2),

Formulation: 65% wt NaLAS, 18% wt Zeolite 4A, 12% carbonate, 1% sulphate, 4% moisture

LAS acid in some cases spiked with 50 ppm Fe from FeSO₄ When included, Tinogard is pre-mixed with Zeolite, Citric Acid is premixed with LAS acid.

Malodor scores after 7 days at 45° C. in closed jars:

| | | | Granule Fe |
|---|---|---|---|
| Code | Composition | Malodour | content (ppm) |
| L2264- | Not spiked | 2 | 10 |
| 01/75 | | | |
| L2264- | Spiked, 2% wt | 1.3 | 40 |
| 06/40 | citric acid, | | |
| | 0.25% wt | | |
| | Tinogard | | |

Fe content was determined by standard chemical analysis

Malodor Protocol

Samples of about 200 mL were taken from the process and stored in closed glass jars (reference i.e. not spiked and no Fe present) at 45° C. in a climate cell. Samples were analysed after 7 days on malodour intensity, which was scored by a panel of 5 people. The evaluators had been trained under supervision of a perfume expert. The samples were first allowed to reach ambient conditions after removal from the climate cell. A few hours after removal, the lids were unscrewed to open and the samples were “sniffed” by the panel. Scores were given on a scale of 1-5, where 5 is high malodour.

1. Powdered detergent composition obtained by a thin layer drying process and comprising:
1 wt % to balance of anionic surfactants
0 to 25 wt %, preferably 1 to 10 wt % of fatty acid derivatives, in particular fatty acid soaps
up to 75 wt %, in particular 1 to 25 wt % of a support material
less than 25 wt %, preferably less than 10 wt % and in particular 1 to 5 wt % of total water (i.e. sum of free and bound water)
0 to 3 wt % of perfumes
0 to 75 wt %, preferably 0 to 50 wt % and in particular 5 to 30 wt % of builder material
0.05 to 5 wt %, in particular 0.1 to 3 wt % and most preferably 0.2 to 2 wt % of a sequestrant and/or anti-oxidant, while the composition contains more than 10 ppm, in particular 10 to 1000 ppm of transition (heavy) metal ions, in particular derived from Fe or Cu.

2. Detergent composition according to claim 1 wherein the anionic surfactant is selected from salts of LAS and/or PAS.

3. Detergent composition according to claims 1 and 2 wherein the amount of anionic surfactant is 5 to 75 wt %, preferably 10 to 50 wt %.

4. Detergent composition according to claims 1 to 3 wherein the soap is a fatty acid salt from a fatty acid with 12 to 20 C-atoms, in particular with 16 to 18 C-atoms.

5. Detergent composition according to claims 1 to 4 wherein the sequestrant and or anti-oxidant is selected from the group consisting of: EDTA; STP; Citric acid; a BHT derivative such as Tinogard; or Irganox or Tetronic.

6. Detergent composition according to claims 1 to 5 wherein the support is selected from the group consisting of: zeolites; Al-silicates; silicates, alkali carbonates or alkali hydrogencarbonates; cellulose derivatives; polymers or copolymers from Na-acrylate.

7. Detergent composition according to claims 1 to 6 wherein the composition is free of an ultraviolet absorber.

8. Detergent composition according to claims 1 to 7 wherein the composition also comprises up to 20 wt % of other surfactants, in particular up to 20 wt % of non-ionic and/or cationic surfactants.

9. Detergent composition according to claims 1 to 8 wherein the composition has an untapped bulk density of more than 600 g/l.

10. Process for the production of powdered detergent composition with the composition according to claims 1 to 9, wherein the ingredients of the detergent composition, comprising at least part of the total amount present in the whole composition of at least one of the ingredients selected from the group consisting of support material, anti-oxidant and sequestrant are introduced in a mixer at a first point of introduction and homogenised at a temperature between 10 and 160° C. while the remainder of anti-oxidant and/or sequestrant and/or support material is introduced in the mixer at a second point of introduction downstream from the first point of introduction, while the mixture obtained can be sprayed dried by spraying it on the support material.

11. Process according to claim 10 wherein the mixer applied is selected from the group consisting of:
a scraped wall heat exchanger/mixer/drier, a high shear mixer granulator; a medium shear mixer granulator, or a low shear mixer granulator.

12. Process according to claims 10 and 11 wherein the mixer is selected from a VRV mixer.

13. Process according to claims 10 to 12 wherein the VRV mixer is applied with a tip speed of 10 to 50 m s⁻¹, preferably 18-45 and most preferably 30 to 40 m.s⁻¹, and a distance between wall and blades of up to 10 mm.

14. Process according to claims 10 to 13 wherein the VRV mixer is used with a heater shell area of up to 32 m², an inner superficial gas velocity (countercurrent) of up to 4 m.s⁻¹, pref up to 2 m.s⁻¹ and a residence time of up to 300 sec, preferably up to 60 sec.
